(19) United States
(12) Patent Application Publication
(10) Pub. No.: US 2011/0141336 A1
(43) Pub. Date: Jun. 16, 2011

(54) PHOTOCHROMATIC COATING FOR CONTROLLING LENS FLARE

(75) Inventor: Adam Mittleman, San Francisco, CA (US)

(73) Assignee: Apple Inc., Cupertino, CA (US)

(21) Appl. No.: 12/635,884

(22) Filed: Dec. 11, 2009

(51) Int. Cl. H04N 5/225; G02B 5/23

(52) U.S. Cl. 348/340; 359/614; 348/373; 348/E05.024

(57) ABSTRACT

A camera lens can be subject to lens flare due to light reaching a camera sensor from outside of the camera field of view. When an electronic device size is reduced such that a lens cannot be recessed relative to the device housing, the lens can capture stray light. To reduce the chance that stray light reaches the lens and sensor, the lens can be treated with a photochromatic treatment. Properties of the photochromatic treatment, as well as the distribution of the treatment can be selected to reduce lens flare caused by particular types of light. In some embodiments, a photochromatic treatment can instead or in addition be applied for a cosmetic purpose. For example, a photochromatic treatment can be applied to a device housing, icons or text displayed on the device enclosure, on a mask within a device display window, or any other electronic device enclosure component.

### BACKGROUND OF THE INVENTION

This is directed to using a photochromatic coating on plastic or glass used as part of a camera assembly to control lens flare.

The exterior of many electronic devices can include a housing combined with a display area. The housing can include one or more openings through which a sensor or input interface can be accessed. For example, the housing can include one or more openings through which a button can be accessed. As another example, the housing can include one or more openings for a connector interface used to connect the device to a host device or to a power supply. As still another example, the housing can include an opening through which a sensor can receive or detect information from the user's environment. In one implementation, the housing can include an opening for a camera operative to detect light reflected from the user's environment.

To capture an image, a camera sensor of the electronic device can receive light from the environment, which passes through the housing opening and is detected by the sensor. The sensor can be protected from damage by a lens that is embedded or connected to the electronic device housing. The lens shape can be selected based on any suitable criteria, including for example to ensure that light received through the lens is minimally distorted as it travels to the sensor.

The lens shape, however, may allow stray light that is not within the field of view of the sensor to pass through the lens and strike the sensor. This can cause lens flare or other bright spots in an image detected by the sensor, and adversely affect an image captures and stored by the camera.

### SUMMARY OF THE INVENTION

This is directed to coating a lens of an electronic device with at least one photochromatic coating to reduce lens flare in images captured by a camera. In addition, this is directed to using one or more photochromatic coatings to provide a cosmetic finish for an electronic device.

Controlling lens flare in an electronic device camera is a well-known problem. In many existing devices, a camera lens can be recessed within a housing, or a device component can extend around and beyond the periphery of the lens such that stray light causing lens flare can be prevented from reaching the lens. As devices get smaller, however, the housing may not be sufficiently large to include a component extending beyond the periphery of the lens, or to recess the lens within the housing. The resulting lens may then be subject to lens flare and adversely affect images captured by the device.

To control lens flare in a device where the lens is substantially co-planar with the outer most surface of a housing, the lens can be treated using a photochromatic treatment. The photochromatic treatment can be tailored or tuned to reduce lens flare in one or more particular situations. In particular, the distribution of the treatment on the lens, the density or effectiveness of the treatment, the particular materials used for the treatment, and the type of treatment (e.g., coating or embedding molecules within the lens material) can be controlled and selected based on a desired final result. For example, a photochromatic treatment can include a photochromatic coating defining a ring around the periphery of a lens, and tailing off towards the center of the lens such that the center of the lens does not include any treatment.

In some embodiments, a photochromatic treatment can instead or in addition be applied to a cosmetic surface of an electronic device to provide a particular aesthetic effect. For example, a photochromatic treatment can be applied to a device housing, such that the color of the device housing can change based on the light to which the device is exposed. As another example, a photochromatic treatment can be applied to an icon or text on the device housing that can appear or disappear based on incident radiation. As still another example, a photochromatic treatment can be applied to a mask of the electronic device window, such that the mask can change colors to match an electronic device display.

The treatment can include any suitable type of treatment for which color can change. In particular, the treatment can change color based on any suitable trigger or detected condition, such as temperature, electrical current, solvent polarity, ions, change in pH, mechanical friction, mechanical pressure, or any other suitable trigger.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative electronic device in accordance with one embodiment of the invention;

FIG. 2 is a schematic back view of the electronic device of FIG. 1 in accordance with one embodiment of the invention;

FIG. 3 is a cross-sectional diagram illustrating the manner in which light can be transmitted to a camera sensor;

FIG. 4 is a schematic cross-sectional view of an illustrative camera having a hood;

FIG. 5 is a schematic cross-sectional view of a compact camera;

FIG. 6 is a detailed schematic cross-sectional view of the extension and lens of the camera of FIG. 5;

FIG. 7 is a top view of a schematic electronic device housing having a treated lens in accordance with one embodiment of the invention;

FIGS. 8A-8F are schematic cross-sectional views of treatments applied to an electronic device component in accordance with one embodiment of the invention;

FIG. 9 is a schematic view of an electronic device housing to which a photochromatic treatment is applied in accordance with one embodiment of the invention;

FIG. 10 is a schematic view of an electronic device display window to which a photochromatic treatment is applied in accordance with one embodiment of the invention;

FIG. 11 is a schematic view of a keyboard a photochromatic treatment is applied in accordance with one embodiment of the invention; and

FIG. 12 is a flowchart of an illustrative process for creating an electronic device camera lens having a photochromatic treatment in accordance with one embodiment of the invention.

### DETAILED DESCRIPTION

An electronic device can include a camera for capturing images of the user's environment. The camera can include a lens placed along the device housing, and a sensor positioned behind the lens such that light can be gathered by the lens and provided to the sensor. To ensure that images captured by the camera do not include lens flare, the lens can be stepped back relative to the housing. This can prevent stray light that is not within the field of view of the sensor from reaching the sensor.

As electronic devices become smaller, however, the electronic device may become too small for the lens to be recessed, or for a component (e.g., a hood) to extend from the device housing). The resulting electronic device may then have no or limited protection from lens flare, which can adversely affect the quality of images captured by the camera. As an alternative to a recessed lens or a housing extension, a photochromatic treatment or coating can instead be applied to at least one portion of the lens. The photochromatic treatment can be selected such that particular types of light striking the lens can be reflected or absorbed, but not transmitted through the lens to the camera sensor.

Any suitable type of photochromatic treatment can be applied. In some cases, the type of treatment may depend on the type of material used for the lens. For example, different types of coatings can be applied to an upper or lower surface of the lens, or photochromatic particles can be embedded within the lens when it is manufactured. The thickness or other properties of the photochromatic treatment can vary or be constant. For example, the treatment can be applied in a ring around the periphery of the lens such that the thickness or strength of a treatment can decrease and tail off towards the center of the lens.

In some embodiments, a treatment can instead or in addition be applied to an electronic device enclosure to provide a desired cosmetic effect. In particular, the cosmetic effect of surface treatments applied to products having optical components can be of great importance. In consumer product industries, such as the electronics industry, visual aesthetics may be a deciding factor in a consumer's decision to purchase one product over another. Accordingly, there is a continuing need for new surface treatments, or combinations of surface treatments, for surfaces to create products with new and different visual appearances or cosmetic effects.

One such type of treatment is a photochromatic treatment. In particular, a photochromatic treatment will cause a reversible transformation of the treatment by the absorption of electromagnetic radiation, such that the appearance of the treatment can change. For example, the color of a treated component can change based on received radiation. As another example, the opacity of a component (e.g., a transparent window) can change based on received radiation. A photochromatic treatment can be applied to any suitable electronic device enclosure element, including for example a housing, one or more logos or other elements (e.g., such that logo appears or disappears). As another example, a photochromatic treatment can be applied to a window through which a display can provide information, such that the window is dark or opaque when the display is turned off, but transparent or clear when the display is turned on. As still another example, a photochromatic treatment can be applied to portions of a window that are adjacent to a display, such that the color of the adjacent portions changes to match the color of the display.

A photochromatic treatment can be selected based on any suitable criteria. For example, a treatment can be selected based on a wavelength of incident radiation that causes the photochromatic transformation. The wavelength can include, for example, visible light, ultraviolet radiation, infrared radiation, or any other type of radiation. As another example, the amplitude or intensity of detected electromagnetic radiation can be selected to serve as a trigger for the photochromatic reaction. In some embodiments, the electronic device can include one or more components for selectively generating a desired electromagnetic radiation to control the photochromatic transformation.

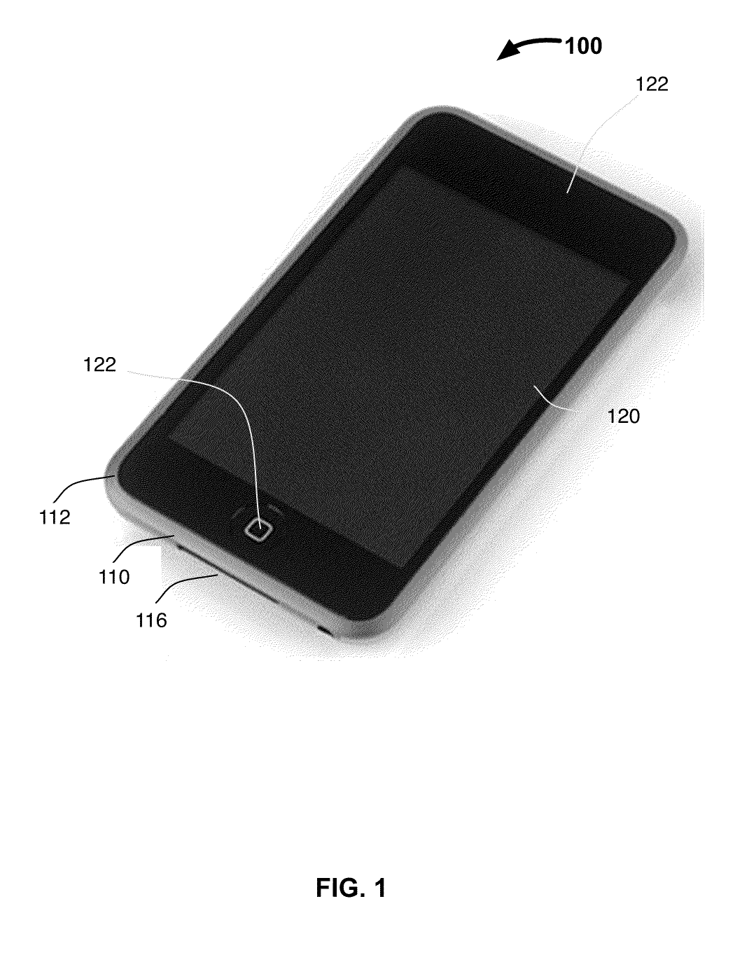

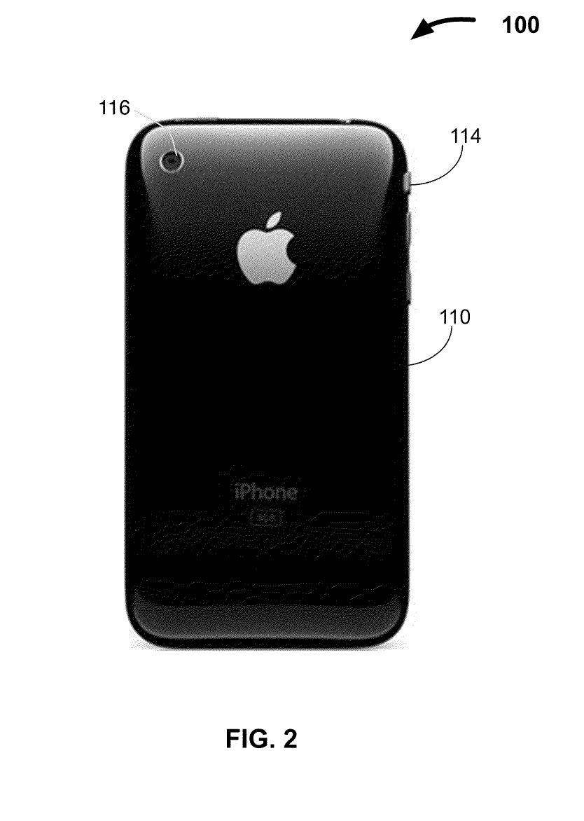

Embodiments of the invention are discussed below with reference to FIGS. 1-12. However, those skilled in the art will readily appreciate that the detailed description given herein with respect to these figures is for explanatory purposes as the invention extends beyond these limited embodiment. FIG. 1 is a schematic front view of an electronic device in accordance with one embodiment of the invention. FIG. 2 is a schematic back view of the electronic device of FIG. 1 in accordance with one embodiment of the invention. Electronic device 100 can include housing 110, bezel 112, and window 120. Bezel 112 can be coupled to housing 110 in a manner to secure window 120 to the bezel. Housing 110 and bezel 112 can be constructed from any suitable material, including for example plastic, metal, or a composite material.

Housing 110, bezel 112, and window 120 can include one or more openings for interfaces via which a user can interact with the electronic device. For example, housing 110 or window 120 can include one or more openings for buttons (e.g., button 122 in window 120, or button 114 in housing 110). As another example, housing 110 can include opening 116 through which one or more connectors can be coupled to the device. As still another example, housing 110 can include openings through which audio or other signals generated by the device can be output to the user (e.g., a speaker grill), or openings through which an electronic device component can capture or detect information regarding the user's environment. For example, housing 110 can include opening 116 through which a camera can capture images of the user's environment.

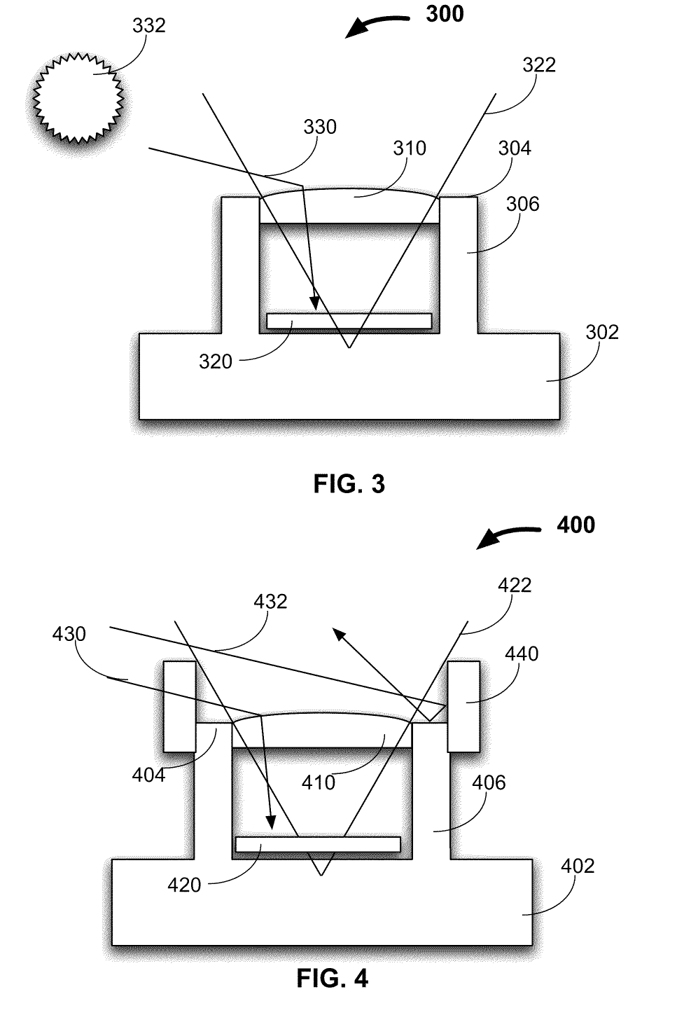

Opening 116 can be fitted with a lens for gather light from the device environment, and redirecting the light to a sensor within the device. The precise disposition of the lens within the device, however, can control the amount of light detected by the sensor, and the origin of the light relative to the sensor field of view. FIG. 3 is a cross-sectional diagram illustrating the manner in which light can be transmitted to a camera sensor. Camera 300 can include body 302 having sensor 320 for receiving light from the camera environment. Camera 300 can include lens 310 offset from sensor 320, and operative to collect light from the environment and direct the light to the sensor. Lens 310 can be substantially aligned with the top surface 304 of extension 306 of body 310, such that camera 300 takes a minimum amount of space within the device.

Lens 310 and sensor 320 can be offset such that camera 300 can have field of view 322. Light received from within field of view 322 can properly be transmitted through lens 310 and be detected by sensor 320 to form an image. Because lens 310 is substantially aligned with top surface 304, light emitted from light source 332 (e.g., the sun) can strike lens 310 from beyond field of view 322. For example, light 330 can originate from beyond field of view 332, be bent by lens 310 and be detected by sensor 330. The additional light 330 can cause a portion of sensor 330 to be overloaded and cause a flare on the resulting image (e.g., a lens flare). It can therefore be important to prevent or limit light originating from beyond field of view 322 from striking sensor 320.

In dedicated cameras (e.g., SLR cameras), a cover or hood can be added to the camera such that the hood extends beyond the lens and the top most surface of the camera. FIG. 4 is a schematic cross-sectional view of an illustrative camera having a hood. Camera 400 can include some or all of the features of camera 300 (FIG. 3). In particular, camera 400 can include body 402, top surface 404, extension 406, lens 410, sensor 420 and field of view 422 having some or all of the features of the corresponding components of camera 300. To prevent stray light originating beyond field of view 422 from reaching sensor 420, camera 400 can include hood 440 coupled to the end of the camera extension. In particular, hood 440 can be coupled to camera 400 such that a distal portion of hood 440 extends beyond lens 410 away from the camera body while a proximal portion of hood 440 includes a coupling mechanism for securing hood 440 to extension 406, adjacent to lens 410. Hood 440 can have any suitable shape, including for example a cylindrical shape having side walls substantially parallel to those of extension 406. Hood 440 can have any suitable height 440, including for example a height selected so as to not affect field of view 422.

Using hood 440, light 430 originating from beyond field of view 422 can strike the outer surface of hood 440, and prevent the light from passing through the lens and to the sensor (e.g., contrary to light 330 of FIG. 3). In addition, light 432 that passes over the outermost (e.g., distal-most) end of hood 440 can strike the inner surface of the hood and be reflected away from the lens, instead of reaching the lens and being transmitted to the sensor. Thus hood 440 can reduce or prevent stray light from reaching sensor 420, and correspondingly reduce lens flare. This approach, however, requires a hood extending from the camera body, and may therefore not be available in a small electronic device (e.g., for a camera integrated in a cellular telephone or a media player)

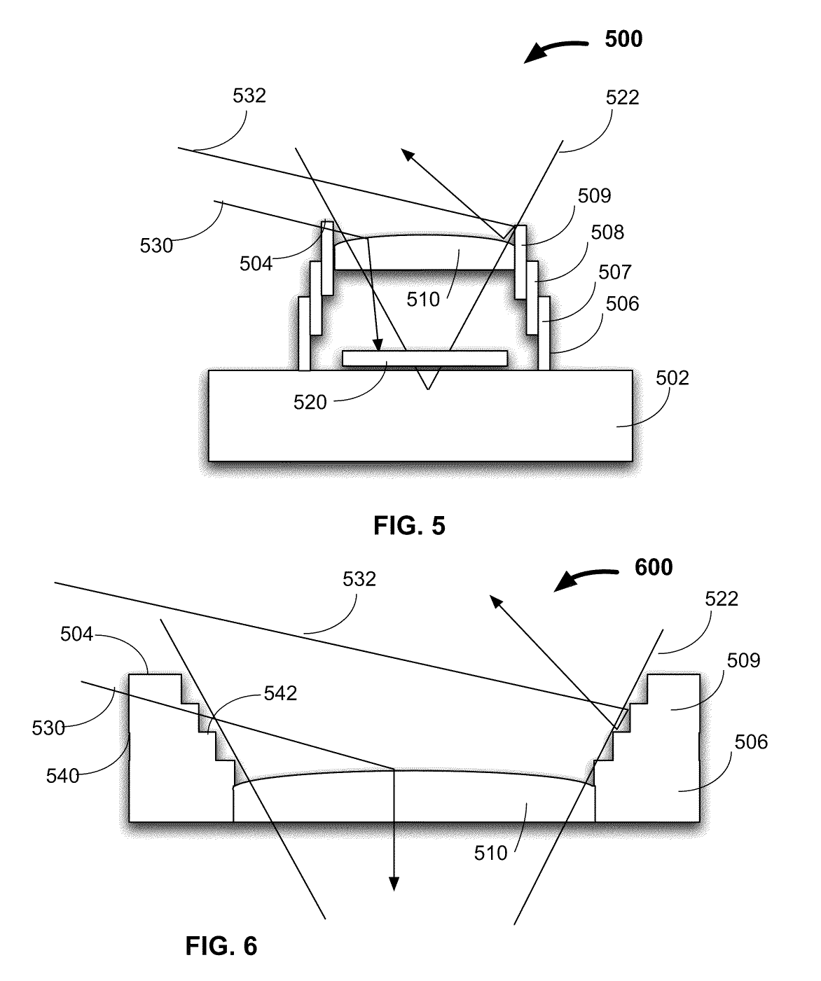

In some embodiments, the lens can instead or in addition be recessed within the camera body. This approach can be used, for example, in point-and-shoot cameras. FIG. 5 is a schematic cross-sectional view of a compact camera. Camera 500 can include body 502 with telescoping extension 506. Lens 510 can be placed within extension 506 such that lens 510 is offset from sensor 520. Extension 506 can be formed from several distinct interlocking elements 507, 508 and 509. The elements can fold or collapse into each other when the device is turned off to save space. Lens 510 can capture light from the camera's environment (e.g., at least light from within field of view 522) and direct the light to sensor 520 for detection and storage.

To prevent lens flare cause by light reaching lens 510 from beyond field of view 522, lens 510 can be recessed relative to top surface 504 of extension 506 (e.g., relative to the outermost surface of the extension). The offset between top surface 504 and lens 510 can prevent some light originating from beyond field of view 522 (e.g., light 530) from reaching lens 510, as the light will instead contact extension 506 (e.g., similar to hood 440, FIG. 4).

In some embodiments, the portion of extension 504 extending beyond lens 510 can include one or more features for preventing light from beyond field of view 522 from being transmitted by the lens. FIG. 6 is a detailed schematic cross-sectional view of the extension and lens of the camera of FIG. 5. Detailed view 600 can include element 509 that is coupled to lens 510. Element 509 can include smooth outer surface 540 and stepped inner surface 542. Stepped inner surface 542 can include any suitable number of steps having any suitable size, including for example a size selected such that light 532 reaching a stepped inner surface 542 is reflected away from lens 530. The particular height or depth of each step can be selected based on any suitable criteria, including for example based on the angle at which light reaches the camera.

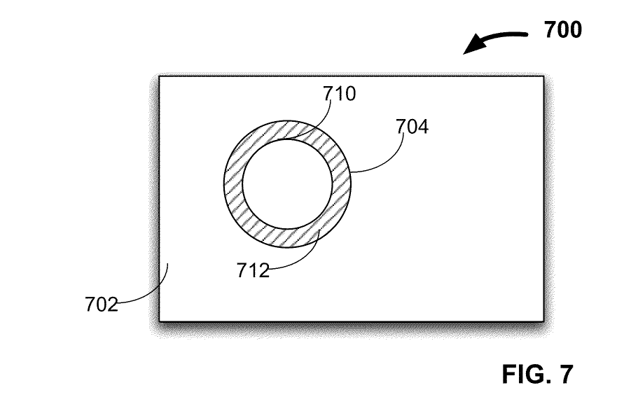

While the approaches shown in FIGS. 4-6 may be effective for reducing or limiting lens flare, they may nevertheless increase the height of the resulting device. In particular, the offset between the top most surface of the camera body and the camera lens can inherently limit how small the device can be. An alternate approach for reducing lens flare without increasing the height of the device (e.g., such that the lens can be substantially at the same height as the top most surface of the camera body or device housing) may then be required. FIG. 7 is a top view of a schematic electronic device housing having a treated lens in accordance with one embodiment of the invention. Device 700 can include housing 702 having opening 704 through which a camera can capture images of the device environment. The camera can include lens 710 operative to capture light and transmit the captured light a sensor within the device.

Lens 710 can be positioned within housing 702 such that it is substantially even or co-planar with the housing (e.g., not recessed within the housing). In particular, housing 702 may not extend beyond lens 710 to form a barrier preventing stray light from reaching the lens and the sensor. Instead, lens 710 can include treatment 712 along at least a portion of lens 710. Treatment 712 can include any suitable type of treatment, including for example one or more coatings or other processes by which material is deposited on a surface, processes for embedding materials within a device component (e.g., embedding particular materials in a glass window), removing material from a device component (e.g., polishing, etching, or roughing a window), or other treatments of device components. The treatments can be applied to one or more surfaces of a component (e.g., of a lens), or within the material used to form the component.

In some embodiments, the particular treatment selected can include a photochromatic treatment. A photochromatic treatment can cause a reversible change of color upon exposure to electromagnetic radiation (e.g., light). For example, a surface treated with a photochromatic coating can transform from substantially transparent to opaque or dark in response to being exposed to UV light. The particular material used to form the photochromatic coating can be selected based on any suitable criteria. In some embodiments, the material can be selected based on an incident angle, the wavelength of detected electromagnetic radiation (e.g., UV, IR, or visible light), the amplitude or intensity of the radiation, or any other suitable criteria. The particular materials or distribution of the photochromatic treatment can be tuned or tailored to reduce lens flare.

Treatment 712 can be applied to any suitable portion of lens 710. In some embodiments, treatment 712 can be applied to portions of lens 710 that may be more susceptible to receiving stray light from beyond the field of view of the camera. For example, treatment 712 can be limited to a ring around the periphery of lens 712. The particular disposition or distribution of treatment 712 can be uniform (e.g., symmetrical) or appear more arbitrary. For example, the treatment area can be larger in areas where stray light is more likely to reach the lens (e.g., larger treatment area along the bottom of the lens rather than along the top of the lens). In some embodiments, the treatment strength can instead or in addition vary along the lens. For example, treatment 712 can be strongest along the outermost periphery of lens 710, and tail off or decrease as the treatment moves towards the center of the lens. Any suitable amount of the lens can be treated, including for example most or all, or only some (e.g., only a ring around the periphery of the lens). The strength of the treatment can be controlled using any suitable approach. For example, the thickness or density of a coating can vary. As another example, the types of materials or molecules used to form the treatment can change

Treatment 712 can prevent stray light from reaching the device sensor using any suitable approach. In some embodiments, as treatment 712 changes colors in response to a particular incident electromagnetic radiation, the colored treatment 712 can absorb electromagnetic radiation that reaches the treatment. Because the treatment can be defined to absorb only a particular type of electromagnetic radiation (e.g., absorb radiation within a particular frequency range), the radiation that would cause lens flare can be absorbed and prevented from reaching the sensor. Because the particular radiation causing lens flare may nevertheless be desirable when it originates within the field of view of the sensor and lens, the area of treatment 712 can be limited to areas where stray light is most likely to reach the lens (e.g., around the periphery of the lens).

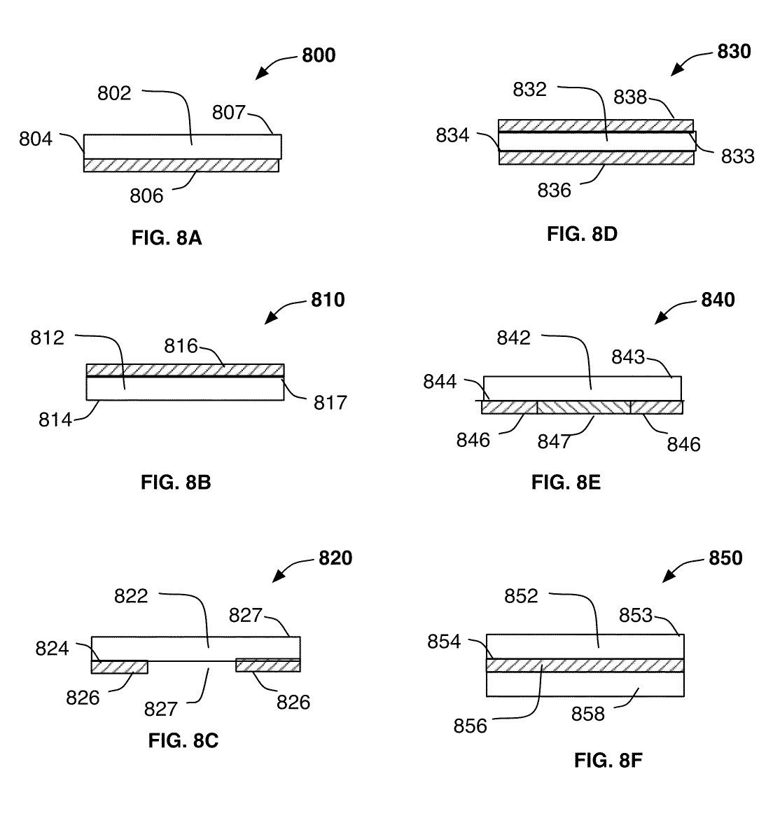

A photochromatic treatment can be applied to an electronic device component using any suitable approach. In some embodiments, a treatment can be applied using a coating. FIGS. 8A-8F are schematic cross-sectional views of treatments applied to an electronic device component in accordance with one embodiment of the invention. Device 800 can include component 802 having top surface 803 and bottom surface 804. Treatment 806 can be applied to bottom surface 804 to provide a desired cosmetic finish. Treatment 806 can be formed from one or more layers of one or more materials, including for example several layers of different materials having different optical properties. In some embodiments, one or more of the layers can be formed from a photochromic complex. Device 810 can include component 812 having top surface 813 and bottom surface 814. Treatment 816 can be applied to top surface 813 to provide a desired cosmetic finish, and can include some or all of the features of treatment 806.

Device 820 can include component 822 having top surface 823 and bottom surface 824. Treatment 826 can be applied to bottom surface 824 to provide a desired cosmetic finish, and can include some or all of the features of treatment 806. Treatment 826 can include one or more gaps or holes 827 caused by a mask placed on the surface of component 822 when treatment 826 was applied. In some embodiments, treatment 826 can instead or in addition be applied to top surface 822. Device 830 can include component 832 having top surface 833 and bottom surface 834. Treatment 836 can be applied to bottom surface 834 to provide a desired cosmetic finish, and treatment 838 can be applied to top surface 833. Treatments 836 and 838 can include some or all of the features of treatment 806. Treatments 836 and 838 can be constructed from the same or different materials or types of materials, and can have the same or different thicknesses. In some embodiments, each of treatments 836 and 838 can include different combinations of individual material layers and holes (e.g., created by the application of masks, as shown in device 820) to provide a desired cosmetic appearance.

Device 840 can include component 842 having top surface 843 and bottom surface 844. Treatments 846 and 847 can be applied to bottom surface 844 to provide a desired cosmetic finish, and can include some or all of the features of treatment 806. In some cases, treatments 846 and 847 can be positioned adjacent to each other in the same plane relative to the component device surface (e.g., such that different portions of the same component device provide different photochromatic cosmetic effects). In some embodiments, treatments 846 and 847 can instead or in addition be applied to top surface 843. The particular materials or thickness of each of treatments 846 and 847 can be different to provide a specific cosmetic effect (e.g., a logo or shape visible in device 840). Device 850 can include component 852 having top surface 853 and bottom surface 854. Treatment 856 can be applied to bottom surface 854 to provide a desired cosmetic finish, and can include some or all of the features of treatment 806. Device 850 can in addition include second component 858 coupled to treatment 856 such that treatment 856 is between component elements 852 and 858. In some embodiments, second component 858 can instead or in addition include any other transparent or translucent material, such as for example plastic. In some embodiments, device 850 can include other combinations of component and material layers, including for example any suitable combination of the device cross-sections described in FIGS. 8A-F.

A photochromatic treatment can be applied using any suitable photochromic complex or molecule. For example, the photochromic molecules can include molecules belonging to the classes of triarylmethanes, stilbenes, azastilbenes, nitrones, fulgides, spiropyrans, naphthopyrans, spiro-oxazines, quinones, or any other suitable class. Some photochromatic molecules can be non-organic, such as silver chloride, or other silver and zinc halides. In some embodiments, the photochromic molecules can be attached to metal complexes providing various properties (e.g., luminescence, magnetism, or corrosion resistance).

Using the attached complex of a photochromic complex, one or more cosmetic effects of the photochromatic treatment can be controlled. For example, a photochromatic treatment can seamlessly switch between two colors defined by a photochromic dye of the photochromic complex. The colors can be selected based on any suitable cosmetic criteria. In some embodiments, the photochromic complex can be selected to control the opacity of a photochromatic treatment. For example, an electronic device component can be substantially transparent in the absence of direct natural light (e.g., detected from UV radiation), but opaque so as to provide a mirror-like effect when exposed to natural light.

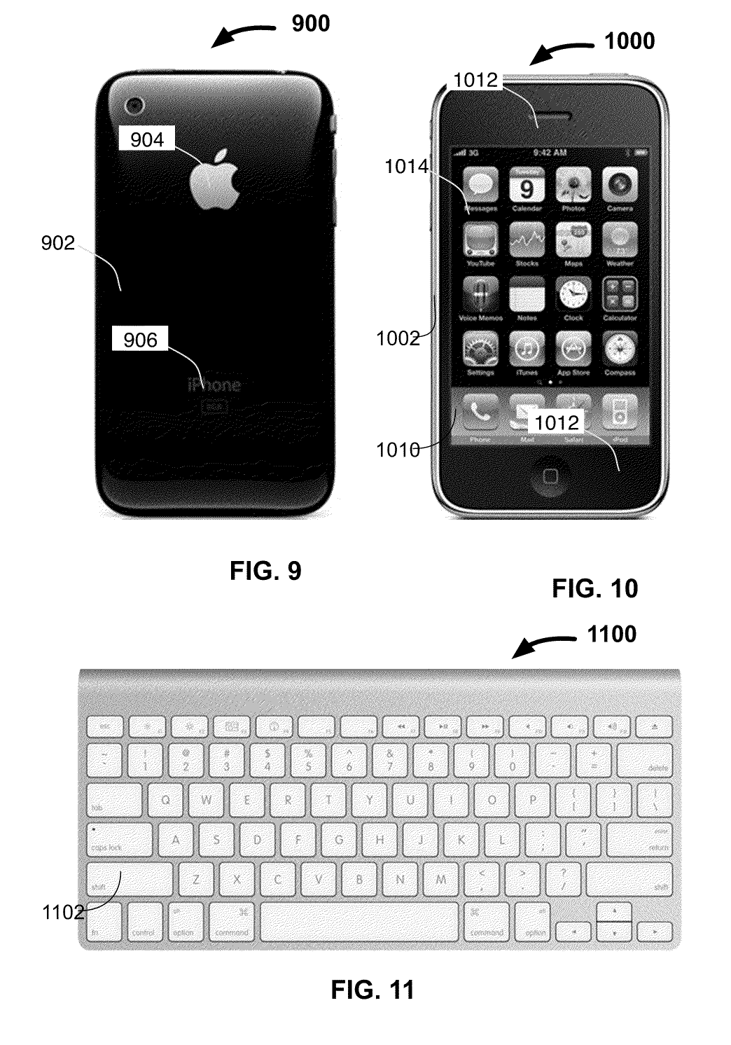

A photochromatic treatment can be applied to any electronic device component for cosmetic purposes. FIG. 9 is a schematic view of an electronic device housing to which a photochromatic treatment is applied in accordance with one embodiment of the invention. Electronic device 900 can include housing 902 on which icon 904 and text 906 can be displayed. To provide a cosmetic finish, a photochromatic treatment can be applied to one or more of housing 902, icon 904 and text 906. For example, a photochromatic treatment can be applied to housing 902 such that the housing color varies based on the light in which the housing is held. For example, the housing can be a first color in artificial light and a second color in natural light. In some cases, a user can hold the device in such a manner as to provide light from reaching portions of the housing, thus in effect creating a temporarily multi-color housing.

In some embodiments, a photochromatic treatment can be applied to icon 904 or text 906. The particular colors of the treatment can be selected based on any suitable criteria, including for example a first color that matches housing 902 (e.g., such that icon 904 or text 906 can be invisible or disappear within the housing) and a second color that is complimentary to the housing color (e.g., to provide a cosmetic finish). The icon or text can provide any suitable information, including for example hidden ownership information (e.g., the owner's name hidden on the housing) so that a user can easily identify his device by exposing the device to particular known electromagnetic radiation (e.g., UV light from the sun).

FIG. 10 is a schematic view of an electronic device display window to which a photochromatic treatment is applied in accordance with one embodiment of the invention. Electronic device 1000 can include bezel 1002 surrounding display window 1010. Display window 1010 can include one or more mask portions 1012 around the periphery of display area 1014. Mask portions 1012 may serve to hide from view portions of display window 1010 that are not adjacent to the display area. In particular, mask portion 1012 may hide from view electronic device components or other components or circuitry that are within the device. To provide a cosmetic and aesthetically pleasing display window, a photochromatic treatment can be applied to mask portions 1012 so that the color of the mask portions can match one or more colors of display area 1014. For example, display area 1014 can include a dark or black background when the display is in use. Mask portion 1012 can include a treatment such that when the display is in use, it provides electromagnetic radiation that causes the treatment color to change and match the display color. When the display is off, the color of mask portion 1012 can be selected to match bezel 1102, a housing (e.g., housing 902, FIG. 9), or any other suitable color.

FIG. 11 is a schematic view of a keyboard a photochromatic treatment is applied in accordance with one embodiment of the invention. Keyboard 1100 can include keys 1102 that a user can press to provide inputs to an electronic device. A photochromatic treatment can be applied to some or all of the keys 1102 to provide a cosmetic effect. For example, the illumination of an outline of each key can change based on the ambient light. As another example, the color of a key or of a glyph displayed on the key can change to call attention to the keys or to assist a user in reading the keys based on the light conditions.

In some embodiments, other treatments causing the treated component to change color can be used instead of or in addition to a photochromatic treatment. For example, treatments causing a change in color or opacity based on temperature (e.g., thermochromism), electrical current (e.g., electrochromism), solvent polarity (e.g., solvachormism), ions (e.g., ionochromism), change in pH (e.g., halochromism), mechanical friction (e.g., tribochromism), mechanical pressure (e.g., piezochromism) can be used instead or in addition to electromagnetic radiation. The particular molecules or materials used for the treatments can include one or both of organic and inorganic molecules.

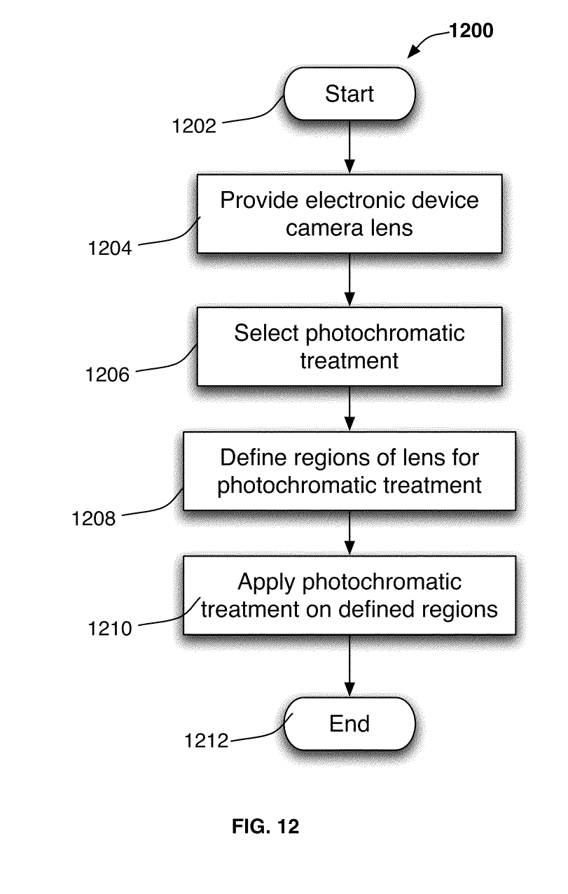

FIG. 12 is a flowchart of an illustrative process for creating an electronic device camera lens having a photochromatic treatment in accordance with one embodiment of the invention. Process 1200 can begin at step 1202. At step 1204, one or more electronic device camera lens can be provided. For example, a piece of material used to create one or more camera lens can be provided. The lens can be substantially formed (e.g., grinded to an appropriate shape), or at an initial state. In some embodiments, the lens can be raw material that is to be processed to form a rigid shape serving as a lens. At step 1206, a particular photochromatic treatment can be selected. For example one or more particular materials to use for a photochromatic treatment can be selected. As another example, one or more methods of applying the treatment can be selected (e.g., coating or embedding particles within the lens material.

At step 1208, regions of the lens to which the photochromatic treatment is to be applied can be defined. For example, a region around the periphery of a lens can be selected. As another example, the distribution of the photochromatic treatment on the lens can be defined (e.g., a variable distribution). As still another example, the intensity or strength of the treatment can be defined (e.g., a variable density). At step 1210, the photochromatic treatment can be applied on the defined regions of the lens. For example, one or more coatings of a photochromatic material can be applied to the lens. As another example, a photochromatic molecule or complex can be inserted in a lens material manufacturing process. Process 1200 can then end at step 1212.

The previously described embodiments are presented for purposes of illustration and not of limitation. It is understood that one or more features of an embodiment can be combined with one or more features of another embodiment to provide systems and/or methods without deviating from the spirit and scope of the invention. The present invention is limited only by the claims which follow.

What is claimed is:

1. A method for providing a photochromatic treatment on a camera lens, comprising:
providing an electronic device camera lens;
selecting a particular photochromatic treatment to apply to the lens for reducing lens flare;
defining at least one region of the lens on which to apply the treatment; and
applying the photochromatic treatment on the at least one defined region.

2. The method of claim 1, further comprising:
coupling the lens to an electronic device housing.

3. The method of claim 2, wherein coupling further comprises:
coupling the lens in a hole of the electronic device housing such that the lens is substantially coplanar with an outermost surface of the electronic device.

4. The method of claim 2, wherein coupling comprises:
coupling the lens to the electronic device housing such that the lens is not recessed within the electronic device housing.

5. The method of claim 1, wherein applying further comprises:
applying a photochromatic treatment of a varying strength on the at least one region.

6. The method of claim 5, wherein:
the strength of the photochromatic varies from stronger to weaker towards the center of the lens.

7. The method of claim 1, wherein:
the at least one region comprises a ring around the periphery of the lens.

8. The method of claim 1, wherein the photochromatic treatment comprises at least one of:
a coating; and
embedding molecules within the lens material.

9. The method of claim 1, wherein selecting a particular photochromatic treatment further comprises:
identifying properties of electromagnetic waves causing lens flare; and
selecting a photochromatic treatment that reacts to electromagnetic waves having the identified properties.

10. The method of claim 9, further comprising:
tuning a photochromatic treatment to reduce the transmission of electromagnetic waves causing lens flare through the lens.

11. An electronic device having an integrated camera, comprising:
a housing forming a portion of an external enclosure of the device;
a camera sensor within the housing, the sensor operative to receive light collected from the environment of the device; and
a lens incorporated in the housing, the lens treated using a photochromic complex to reduce stray light transmitted through the lens to the sensor.

12. The electronic device of claim 11, wherein:
the camera sensor is offset from the lens such that light gathered by the lens is transmitted to the camera sensor.

13. The electronic device of claim 12, wherein:
the offset between the camera sensor and the lens defines a field of view for the camera; and
the photochromic complex is distributed on the lens to reduce the amount of light originating from outside of the defined field of view captured by the lens and transmitted to the sensor.

14. The electronic device of claim 11, wherein:
the photochromic complex is placed in a particular region of the lens.

15. The electronic device of claim 14, wherein:
the photochromic complex is distributed in a ring along the periphery of the lens.

16. The electronic device of claim 11, wherein:
the lens is substantially co-planar with an outermost portion of the housing.

17. A method for providing a cosmetic photochromatic treatment on an electronic device enclosure, comprising:
identifying at least one exposed region of an electronic device enclosure for receiving a photochromatic treatment; and
applying the photochromatic treatment to the identified at least one region for cosmetic effect.

18. The method of claim 17, further comprising:
selecting attributes of the photochromatic treatment to match the color of at least a second region of the electronic device enclosure.

19. The method of claim 17, wherein the at least one region comprises at least one of:
a housing;
an icon displayed on the enclosure;
text displayed on the enclosure; and
a mask adjacent to a display of the electronic device.

20. The method of claim 17, wherein applying further comprises:
applying a photochromatic coating on the at least one region.
